(19) United States
(12) Patent Application Publication
(10) Pub. No.: US 2003/0215768 A1
(43) Pub. Date: Nov. 20, 2003

(54) Dental/medical handpiece

(76) Inventors: Paul M. Aumuller, Richmond Hill (CA); Paolo Accettone, Pickering (CA)

Correspondence Address: HOFBAUER ASSOCIATES, SUITE 205 NORTH, 1455 LAKESHORE ROAD, BURLINGTON, ON, L7S 2J1, CA

(21) Appl. No.: 10/147,818

(22) Filed: May 20, 2002

(51) Int. Cl. A61C 1/12; A61C 3/02

(52) U.S. Cl. 433/130; 433/88; 433/29

(57) ABSTRACT

A dental/medical handpiece having a flexible portion is disclosed. In one embodiment, the handpiece is an abrasion handpiece, for use with a flow of gas having abrasive material entrained therewithin, and comprises a housing including a handle, a nozzle-receiving portion and a flexible neck connecting the handle to the nozzle-receiving portion. A nozzle rigidly attached to the nozzle-receiving portion of the housing is also provided, as is a gas tube. The gas tube has a first end adapted to receive said flow, and extends, from said first end, through the handle, the neck portion and the nozzle-receiving portion, to the nozzle, to direct said flow to issue through the nozzle, outwardly from the housing. In another embodiment, the handpiece is a rotary tool, for use with a rotary bit, such as a dental drill. In a further embodiment, the handpiece is a laser handpiece, for use with a laser generator.

### FIELD OF THE INVENTION

The present invention relates to the field of dental and medical instruments, and more particularly, to a dental/medical handpiece having a flexible neck portion.

### BACKGROUND OF THE INVENTION

In the prior art, numerous devices having angled portions have been proposed to facilitate device manipulation in various dental/medical procedures. However, it is not known in the prior art to provide a dental/medical handpiece having a flexible portion.

### SUMMARY OF THE INVENTION

In accordance with the present invention there is disclosed a dental/medical handpiece having a flexible portion to facilitate ease of use and manipulation of the instrument during use.

In a first preferred embodiment of the present invention, the dental/medical handpiece is for use with a rotary bit, and comprises a housing and a chuck. The housing has a handle portion, a chuck-receiving portion and a flexible, elongate neck portion extending between and connecting the handle portion and the chuck-receiving portion. The chuck has a frontward end, a rearward end and a longitudinal axis extending therebetween, and is adapted to releasably grip said bit such that said bit extends frontwardly from said chuck, substantially coincident with the longitudinal axis. Further, the chuck is positioned proximal to the chuck-receiving portion and orientated relative thereto such that the frontward end of the chuck faces away from the chuck-receiving portion.

Also provided is a shaft, which rigidly extends rearwardly from the rearward end of the chuck and is operatively mounted to the chuck-receiving portion for rotation about the longitudinal axis, as well as a drive means for driving said rotation of the shaft.

In a second preferred embodiment of the present invention, the dental/medical handpiece is for use with a flow of gas having abrasive material entrained therewithin and comprises a housing and a nozzle. The housing has a handle portion, a nozzle-receiving portion and a flexible, elongate neck portion extending between and connecting the handle portion and the nozzle-receiving portion. The nozzle is rigidly attached to the nozzle-receiving portion of the housing and faces away therefrom. Also provided is a gas-directing means for receiving said flow of gas having abrasive material entrained therewithin and for directing same to issue through said nozzle.

As other aspects of the present invention, the dental/medical handpiece for use with a flow of gas having abrasive material entrained therewithin is preferably also for use with a flow of an aerosol comprising a gas and a liquid suspended in said gas; has formed in its housing, arrayed about the nozzle, a plurality of outlet ports; and has aerosol-directing means for receiving said flow of aerosol and directing same to issue through the outlet ports.

In another embodiment of the present invention, the dental/medical handpiece is for use with a laser generating device, and comprises a housing and a laser head. The housing has a handle portion, a head-receiving portion and a flexible, elongate neck portion extending between and connecting the handle portion and the head-receiving portion. The laser head includes collimating means for receiving light and producing therefrom a collimated beam and a focussing means for receiving said collimated beam and producing therefrom a beam of convergent light.

The laser head is rigidly attached to the head-receiving portion of the housing such that, in use, said beam of convergent light is directed away from the head-receiving portion. A flexible laser fibre is also provided, and has a first end couplable to said laser generating device to receive laser beam output therefrom and extends from said first end to a second end which is positioned so as to deliver said laser beam output to said collimating means.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the according to the present invention, as to its structure, organization, use and method of operation, together with further objectives and advantages thereof, will be better understood from the following drawings in which three presently preferred embodiments of the invention are illustrated by way of example, with common reference numerals being used in the Figures to denote like parts, from one embodiment to the next. It is expressly understood, however, that the drawings are for the purpose of illustration and description only, and are not intended as a definition of the limits of the invention. In the accompanying drawings:

FIG. 1 is a perspective view of a dental/medical handpiece according to a first preferred embodiment of the present invention;

FIG. 2 is a side cross-sectional view of the structure of FIG. 1;

FIG. 3 is a perspective view of a dental/medical handpiece according to a second preferred embodiment of the present invention;

FIG. 4 is a side cross-sectional view of the structure of FIG. 3;

FIG. 5 is a perspective view of a dental/medical handpiece according to a third preferred embodiment of the present invention; and

FIG. 6 is a side cross-sectional view of the structure of FIG. 5.

### DETAILED DESCRIPTION OF PREFERRED EMBODIMENTS

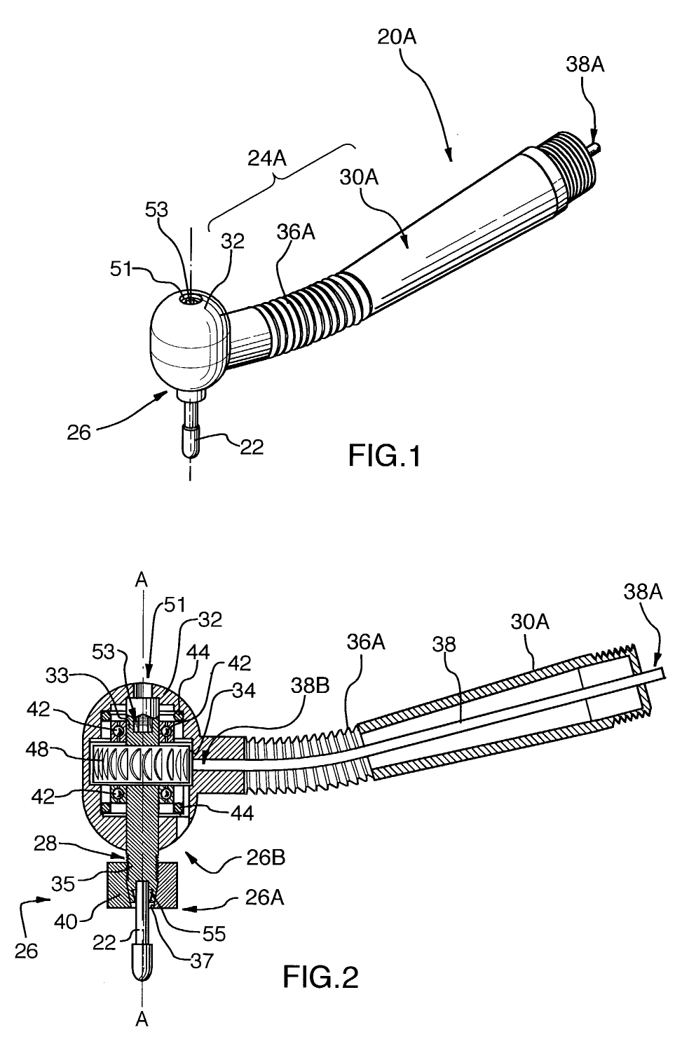

Referring now to FIG. 1 and FIG. 2 of the drawings there is illustrated a dental/medical handpiece according to a first preferred embodiment of the present invention. This handpiece, identified with general reference numeral 20A, is a rotary tool for use with a rotary bit 22, such as a dental fissure bur or the like. For greater certainty, it should be understood that the rotary bit 22 does not form part of the invention.

The handpiece 20A comprises a housing 24A having a handle portion 30A, a chuck-receiving portion 32 and a flexible, elongate neck portion 36A extending between and connecting the handle portion 30A and the chuck-receiving portion 32. The chuck-receiving portion 32 defines a socket 34, and the neck portion 36A is substantially tubular and is constructed from strip-wound, helically-formed convoluted conduit.

Housing 24A further has formed therewithin a flexible gas conduit 38 which has a first end 38A which is couplable to a supply of pressurized gas (not shown), and extends from said first end 38A, through handle portion 30A and neck portion 36A, to a second end 38B in fluid communication with the socket 34.

The chuck 26 has a frontward end 26A, a rearward end 26B and a longitudinal axis A extending between the frontward end 26A and the rearward end 26B, and is adapted to releasably grip the bit 22 such that said bit 22 extends frontwardly from the chuck, substantially coincident with the longitudinal axis A. The chuck 26 is positioned proximal to the chuck-receiving portion 32 and orientated relative thereto such that the frontward end 26A of the chuck 26 faces away from the chuck-receiving portion 32.

The handpiece 20A further comprises a shaft 33 rigidly extending rearwardly from the rearward end 26B of the chuck 26, shaft 33 being operatively mounted to the chuck-receiving portion 32 for rotation about the longitudinal axis A by means of a pair of ball bearing assemblies 42 positioned in socket 34 and connected to the chuck-receiving portion 32 by means of respective O-rings 44.

In the preferred embodiment illustrated, chuck 26 is formed from a radially segmented extension portion 35 of the shaft 33, which portion 35 is provided with a bore 55 to receive the bit 22 and which is also provided with exterior threads 28 to receive a corresponding nut 40. The nut 40 defines interiorly a frusto conical wedging surface 37 shaped and dimensioned to draw the radial segments of the shaft extension 35 together upon engagement of the nut 40, to releasably grip around the bit 22 as aforesaid.

An access aperture 51 is formed through the chuck-receiving portion 32 to provide access to a keyway 53 formed in the shaft 33 into which may be inserted a corresponding key (not shown), such as an Allen key, to immobilize shaft 33 and facilitate engagement and disengagement of the nut 40, for bit replacement.

A plurality of turbine blades 48 are also provided in the first preferred embodiment, and are spaced around and connected to the shaft 33 for rotation therewith. The turbine blades 48 are located so as to be impinged upon by gas delivered from the supply of pressurized gas through the gas conduit 38 and caused to undergo said rotation thereby, along with the shaft 33, the chuck 26 and, when in use, the bit 22. It will be evident, therefore, that the combination of the gas conduit 38 and the turbine blades 48 serves as drive means for driving rotation of said chuck 26, in this embodiment.

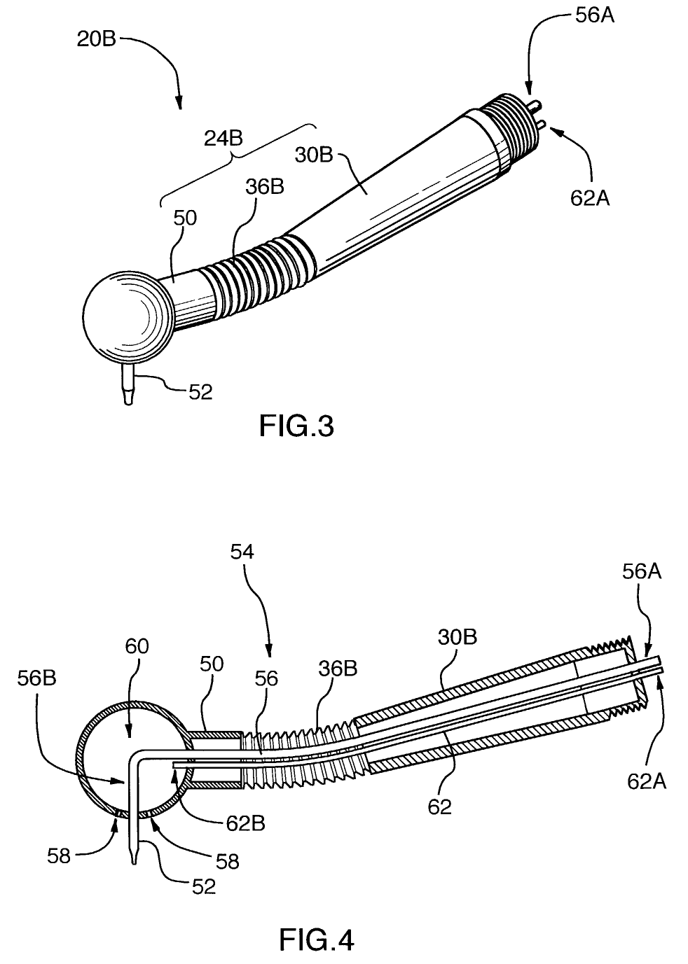

A second preferred embodiment of the handpiece of the present invention, an abrasion tool for use with a flow of gas having abrasive material entrained therewithin, is illustrated in FIG. 3 and FIG. 4 and designated with general reference numeral 20B. This embodiment is similar to the first preferred embodiment, in that it includes a similar housing 24B having a handle portion 30B and a flexible, elongate neck portion 36B. However, in this second preferred embodiment, a nozzle-receiving portion 50 takes the place of the chuck-receiving portion 32 of the first preferred embodiment, such that the neck portion 36B extends between and connects the handle portion 30B and the nozzle-receiving portion 50; a nozzle 52 rigidly attached to the nozzle-receiving portion 50 of the housing 24B, and facing away therefrom, takes the place of the chuck 26; and a gas-directing means is provided, designated with general reference numeral 54, for receiving said flow of gas having abrasive material entrained therewithin and for directing same to issue through nozzle 52.

The gas-directing means 54 comprises a flexible gas tube 56 having a first end 56A which is adapted to receive said flow of gas having abrasive material entrained therewithin and extending from said first end 56A, through the handle portion 30B, the neck portion 36B and the nozzle receiving portion 50, to nozzle 52.

The gas tube 56 is constructed from a material which is flexible, yet able to both contain the abrasive stream and withstand the temperatures and pressures typically encountered in a dental autoclave, so as to facilitate sterilization. PTFE tubing has been found useful in this regard.

The handpiece 20B of the second preferred embodiment may optionally be utilized with a flow of an aerosol comprising a gas and a liquid suspended in said gas. For this purpose, a plurality of outlet ports 58 are formed in the housing 24B, arrayed about the nozzle 52; a cavity 60 is formed in the housing 24B, adjacent to the nozzle 52 and contiguous with the outlet ports 58; and the handpiece 24B is provided with an aerosol-directing means for receiving said flow of aerosol and directing same to issue through the outlet ports 58, namely, a flexible aerosol tube 62 having a first end 62A which is adapted to receive said flow of aerosol and extending from said first end 62A, through the handle portion 30B, the neck portion 36B and the nozzle-receiving portion 50, to the cavity 60.

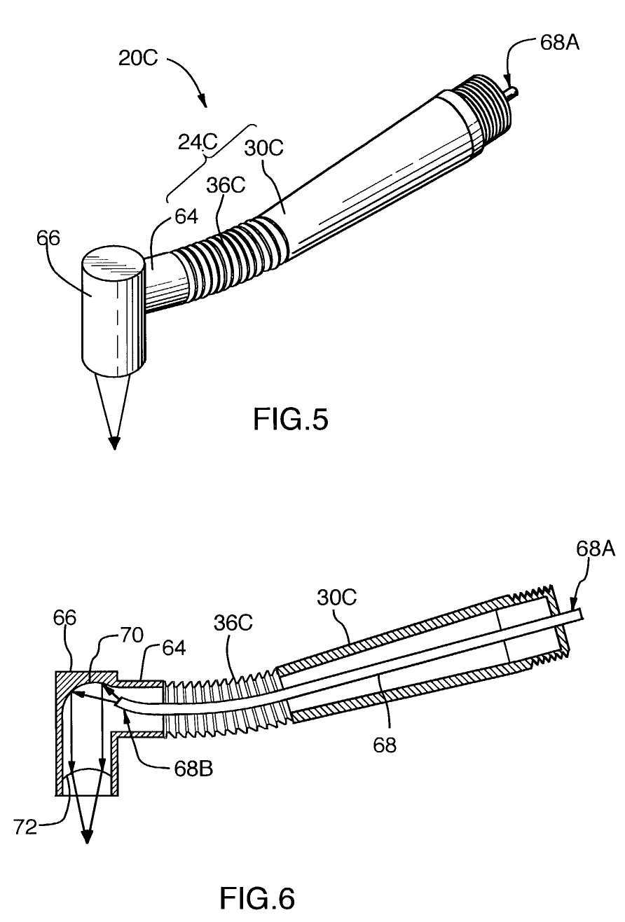

In a third preferred embodiment of the invention, illustrated in FIG. 5 and FIG. 6, the handpiece, designated with general reference 20C, is a laser handpiece, for use with a laser generating device (not shown). The handpiece of this embodiment is also similar to handpiece of the first preferred embodiment, in that it includes a similar housing 24C having a handle portion 30C and a flexible, elongate neck portion 36C.

However, in this embodiment, a head-receiving portion 64 takes the place of inter alia the chuck-receiving portion 32, such that the neck portion 36C extends between and connects the handle portion 30C and the head-receiving portion 64C. As well, a laser head 66 is rigidly attached to the head-receiving portion 64, taking the place of the chuck 26, and a flexible laser fibre 68 is provided for receiving laser beam output from the laser generating device and delivering same to the laser head 66.

The laser head 66 includes collimating means, namely, a collimating mirror 70, for receiving light and producing therefrom a collimated beam, and further includes a focussing means, namely, a focussing lens 72, for receiving said collimated beam and producing therefrom a beam of convergent light, and is rigidly attached to the head-receiving portion 64 of housing 24C such that, in use, said beam of convergent light is directed away from the head-receiving portion 64.

The laser fibre 68 has a first end 68A couplable to said laser generating device to receive laser beam output therefrom, and extends from first end 68A, through the handle portion 30C, the neck portion 36C and the head-receiving portion 64, to a second end 68B which is positioned adjacent the collimating mirror 70 to deliver laser beam light thereto.

The construction and arrangement of laser heads and laser fibres is well-known to persons of ordinary skill in the art of lasers, and as such, is not described herein in detail.

Various modifications and alterations may be used in the design and manufacture of the handpiece according to the present invention without departing from the spirit and scope of the invention.

For example, only, whereas the drive means of the first preferred embodiment comprises turbine blades and a gas tube, it will be evident that an electric motor and electrical conductors could be usefully substituted therefor.

Similarly, whereas in each of the first and second preferred embodiments described herein, separate tubes are provided for the various fluids (gas; gas having abrasive material entrained therewithin; and aerosol), it will be evident that the tubes could be formed, at least in part, integrally with the housing. For example, with reference to FIGS. 1 and 2, rather than providing hollow handle portion 30A, neck portion 36A and chuck-receiving portion 32 as illustrated, with separate gas conduit 38 passing therethrough, the handle portion and chuck-receiving portion could be made substantially solid, each with an individual bore passing therethrough, and the bores coupled to one another in fluid communication by tubular neck portion.

Additionally, whereas the neck portion in the preferred embodiments illustrated is a strip-wound helically-formed conduit, other flexible materials may be utilized. The conduit may also be sheathed with a plastic sleeve, so as to facilitate cleaning, if desired.

Also, it should be understood that while each of the handpieces of the preferred embodiment are constructed from materials capable of withstanding the temperatures and pressures typically encountered in an autoclave, this feature is not necessary, but only preferred.

Accordingly, it should be understood that the scope of the present invention is limited only by the accompanying claims, purposively construed.

We claim:

1. A dental/medical handpiece for use with a rotary bit, the dental/medical handpiece comprising:
a housing having a handle portion, a chuck-receiving portion and a flexible, elongate neck portion extending between and connecting the handle portion and the chuck-receiving portion;
a chuck having a frontward end, a rearward end and a longitudinal axis extending therebetween, the chuck being adapted to releasably grip said bit such that said bit extends frontwardly from said chuck, substantially coincident with the longitudinal axis, and being positioned proximal to the chuck-receiving portion and orientated relative thereto such that the frontward end of the chuck faces away from the chuck-receiving portion;
a shaft rigidly extending rearwardly from the rearward end of the chuck and operatively mounted to the chuck-receiving portion for rotation about the longitudinal axis; and
drive means for driving said rotation of the shaft.

2. A dental/medical handpiece according to claim 1, wherein the neck portion comprises a strip-wound, helically-formed convoluted conduit.

3. A dental/medical handpiece according to claim 2, wherein the chuck-receiving portion defines a socket which substantially surrounds the shaft.

4. A dental/medical handpiece according to claim 3, wherein the shaft is mounted to the chuck-receiving portion by means of a pair of ball bearing assemblies disposed within the socket.

5. A dental/medical handpiece according to claim 4, wherein the drive means comprises:
a gas conduit having a first end couplable to a supply of pressurized gas and extending from said first end, through the handle portion and the neck portion, into the socket of the chuck-receiving portion; and
a plurality of turbine blades spaced around and connected to the shaft for rotation therewith,
the turbine blades being located so as to be impinged upon by gas delivered from the supply of pressurized gas through the gas conduit and caused to undergo said rotation thereby, along with the shaft, the chuck and, in use, said bit.

6. A dental/medical handpiece for use with a flow of gas having abrasive material entrained therewithin and, optionally, a flow of aerosol comprising a gas and a liquid suspended in said gas, the dental/medical handpiece comprising:
a housing having a handle portion, a nozzle-receiving portion and a flexible, elongate neck portion extending between and connecting the handle portion and the nozzle-receiving portion;
a nozzle rigidly attached to the nozzle-receiving portion of the housing and facing away therefrom; and
gas-directing means for receiving said flow of gas having abrasive material entrained therewithin and for directing same to issue through said nozzle.

7. A dental/medical handpiece according to claim 6, wherein the gas-directing means comprises a flexible gas tube having a first end which is adapted to receive said flow of gas having abrasive material entrained therewithin and extending from said first end, through the handle portion, the neck portion and the nozzle-receiving portion, to the nozzle.

8. A dental/medical handpiece according to claim 7, wherein the housing additionally has formed therein a plurality of outlet ports arrayed about the nozzle, and wherein the handpiece further comprises aerosol-directing means for receiving said flow of aerosol and directing same to issue through said outlet ports.

9. A dental/medical handpiece according to claim 8, wherein the housing additionally has a cavity formed therein, adjacent to the nozzle and contiguous with the outlet ports, and the aerosol-directing means comprises a flexible aerosol tube having a first end which is adapted to receive said flow of aerosol and extending from said first end, through the handle, the neck and the nozzle-receiving portion, to the cavity.

10. A dental/medical handpiece according to claim 9, wherein the neck portion comprises a strip-wound, helically-formed convoluted conduit.

11. A dental/medical handpiece for use with a laser generating device, the dental/medical handpiece comprising:
a housing having a handle portion, a head-receiving portion and a flexible, elongate neck portion extending between and connecting the handle portion and the head-receiving portion;
a laser head including collimating means for receiving light and producing therefrom a collimated beam and a focussing means for receiving said collimated beam and producing therefrom a beam of convergent light, said laser head being rigidly attached to the head-receiving portion of the housing such that, in use, said beam of convergent light is directed away from the head-receiving portion; and
a flexible laser fibre having a first end couplable to said laser generating device to receive laser beam output therefrom and extending from said first end to a second end which is positioned so as to deliver said laser beam output to said collimating means.

12. A dental/medical handpiece according to claim 11, wherein the laser fibre extends from its first end, through the handle, the neck and the head-receiving portion, to its second end.

13. A dental/medical handpiece according to claim 12, wherein the neck portion comprises a strip-wound, helically-formed convoluted conduit.

14. A dental/medical handpiece according to claim 13, wherein the collimating means is a collimating mirror.

15. A dental medical handpiece according to claim 14, wherein the focussing means is a focussing lens.
